(19) United States
(12) Patent Application Publication
(10) Pub. No.: US 2003/0169356 A1
(43) Pub. Date: Sep. 11, 2003

(54) Image sensing apparatus and method of controlling same

(76) Inventor: Kazunori Suemoto, Asaka-shi (JP)

Correspondence Address: BIRCH STEWART KOLASCH & BIRCH, PO BOX 747, FALLS CHURCH, VA, 22040-0747, US

(21) Appl. No.: 10/378,739

(22) Filed: Mar. 5, 2003

(30) Foreign Application Priority Data
Mar. 5, 2002 (JP) 2002-058135

(51) Int. Cl. H04N 5/222; H04N 5/335

(52) U.S. Cl. 348/294; 348/333.01

(57) ABSTRACT

Output of one horizontal scanning line of a signal from an effective pixel area of a CCD and writing of image data, which has been converted to digital data, to a line memory are carried out in an effective image display interval. Read-out of image data from the line memory is performed in an ineffective image interval. Since an image represented by image data obtained based upon the effective pixel area is displayed on a display screen, noise produced by DMA transfer clock pulses can be prevented from being superimposed on the image displayed on the display screen.

### BACKGROUND OF THE INVENTION

1. Field of the Invention

This invention relates to an image sensing apparatus and to a method of controlling this apparatus.

2. Description of the Related Art

In an image sensing apparatus such as a digital still camera, the image of a subject is sensed using a CCD, which outputs a signal representing the image of the subject. The output signal of the CCD is applied to a correlated double sampling circuit whereby the black signal portion (feed-through level) serving as the reference and the video signal portion (pixel signal portion) are sampled pixel by pixel. The sampled values of the video signal portion are converted to digital image data.

A digital still camera is provided with two line memories. One horizontal scanning line of image data is written to the two line memories alternatingly and is read out of these memories alternatingly. In other words, when image data is being written to one line memory, image data is read out of the other line memory.

A DMA (Direct Memory Access) controller outputs DMA clock pulses that are applied to the line memories, whereby image data that has been stored in the line memories is read out.

Since the output of the CCD is very small, there are instances where the DMA clock pulses appear as noise with respect to the output signal of the CCD. As a consequence, the video signal portion sampled has noise superimposed upon it and the noise appears in the displayed image of the subject.

### SUMMARY OF THE INVENTION

Accordingly, an object of the present invention is to make it possible to display the image of a subject from which noise has been eliminated.

According to a first aspect of the present invention, the foregoing object is attained by providing an image sensing apparatus (inclusive of a digital still camera, a digital movie camera and a personal digital assistant having a camera function) comprising a solid-state electronic image sensing device for sensing the image of a subject and outputting image data representing the image of the subject; a line memory for storing one horizontal scanning line of image data obtained from an effective imaging area of the solid-state electronic image sensing device; a control unit (control means) for controlling the line memory in such a manner that image data is output from the solid-state electronic image sensing device and, moreover, one horizontal scanning line of image data obtained from the effective imaging area is stored in an effective image display interval; a read-out control unit (read-out control means) for controlling the line memory in such a manner that one horizontal scanning line of image data is read out in an ineffective image interval; and a display control unit (display control means) for controlling a display unit so as to display one horizontal scanning line of an image represented by image data that has been read out of the line memory based upon control by the readout control unit (read-out control means).

The first aspect of the present invention provides also a control method suited to the image sensing apparatus described above. Specifically, the invention provides a method of controlling an image sensing apparatus comprising the steps of: sensing the image of a subject using a solid-state electronic image sensing device and obtaining image data representing the image of the subject; obtaining image data from the solid-state electronic image sensing device and, moreover, writing one horizontal scanning line of image data obtained from an effective imaging area of the solid-state electronic image sensing device to a line memory in an effective image display interval; reading one horizontal scanning line of image data out of the line memory in an ineffective image interval; and controlling a display unit so as to display one horizontal scanning line of an image represented by image data that has been read out of the line memory.

In accordance with the first aspect of the present invention, an image sensing apparatus is provided with a line memory that stores one horizontal scanning line of image data obtained from an effective imaging area of the solid-state electronic image sensing device. Image data is output from the solid-state electronic image sensing device in an effective image display interval and one horizontal scanning line of image data obtained from the effective imaging area is stored in the line memory.

One horizontal scanning line of image data that has been stored in the line memory is read out in an ineffective image interval. The image data that has been read out is applied to a display unit, whereby the image of the subject obtained by imaging is displayed.

In accordance with the first aspect of the invention, image data output from the solid-state electronic image sensing device in the effective image display interval is used to display the image of the subject. Read-out of data from the line memory is not performed in the effective image display interval but is carried out in the ineffective image interval. Since noise produced at read-out of image data from the line memory will not be superimposed upon the image data used in displaying the image of the subject, noise ascribable to read-out of image data from the line memory can be prevented from being displayed on the image of the subject.

According to a second aspect of the present invention, the foregoing object is attained by providing an image sensing apparatus comprising a solid-state electronic image sensing device for sensing the image of a subject and outputting a signal representing the image of the subject; a sampling circuit for sampling, pixel by pixel, a video signal portion of the output signal from the solid-state electronic image sensing device; an analog/digital converter circuit for converting the video signal portion, which has been sampled by the sampling circuit, to digital image data; an image memory for storing digital image data obtained by the conversion by the analog/digital converter circuit and reading out the stored digital image data pixel by pixel in accordance with applied read-out clock pulses; a read-out clock pulse control unit (read-out clock pulse control means) for controlling the read-out clock pulses in such a manner that they are applied to the image memory after sampling of the video signal portion in the sampling circuit; and a display control unit (display control means) for controlling a display unit so as to display an image represented by the image data output from the image memory.

The second aspect of the present invention provides also a control method suited to the image sensing apparatus described above. Specifically, the invention provides a method of controlling an image sensing apparatus comprising the steps of: sensing the image of a subject using a solid-state electronic image sensing device and obtaining a signal representing the image of the subject; sampling, pixel by pixel, a video signal portion of the output signal from the solid-state electronic image sensing device; converting the sampled video signal portion to digital image data; storing the obtained digital image data in an image memory; reading out the digital image data, which has been stored in the image memory, pixel by pixel by applying read-out clock pulses to the image memory after sampling of the video signal portion; and controlling a display unit so as to display an image represented by the image data output from the image memory.

In accordance with the second aspect of the present invention, the video signal portion of an output signal from the solid-state electronic image sensing device is sampled on a per-pixel basis. The sampled video signal portion is converted to digital image data and the data is stored in an image memory. Read-out clock pulses are applied to the image memory, whereby image data that has been stored in the image memory is read out. The image of a subject obtained by imaging is displayed on a display screen by applying the image data that has been read out to a display unit.

The read-out clock pulses applied to the image memory are applied pixel by pixel after the video signal is sampled. The fact that the read-out clock pulses are applied to the image memory after the sampling of the video signal means that noise will not be generated when sampling is carried out. Thus, a video signal portion on which noise has not been superimposed can be sampled. Noise ascribable to readout of image data from the image memory can be prevented from being imposed on the image of a subject.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating part of the electrical structure of a digital still camera according to the present invention;

FIG. 2 illustrates the photoreceptor surface of a CCD;

FIG. 3 is a block diagram illustrating the electrical structure of a digital signal converting circuit according to the present invention;

FIG. 4(A) is a time chart of various signals that flow in a digital still camera according to an embodiment of the present invention;

FIG. 4(B) illustrates a display screen; and

FIG. 5 is a time chart of various signals that flow in a digital still camera according to another embodiment of the present invention.

### DESCRIPTION OF THE PREFERRED EMBODIMENTS

Preferred embodiments of an image sensing apparatus according to the present invention will now be described with reference to the drawings.

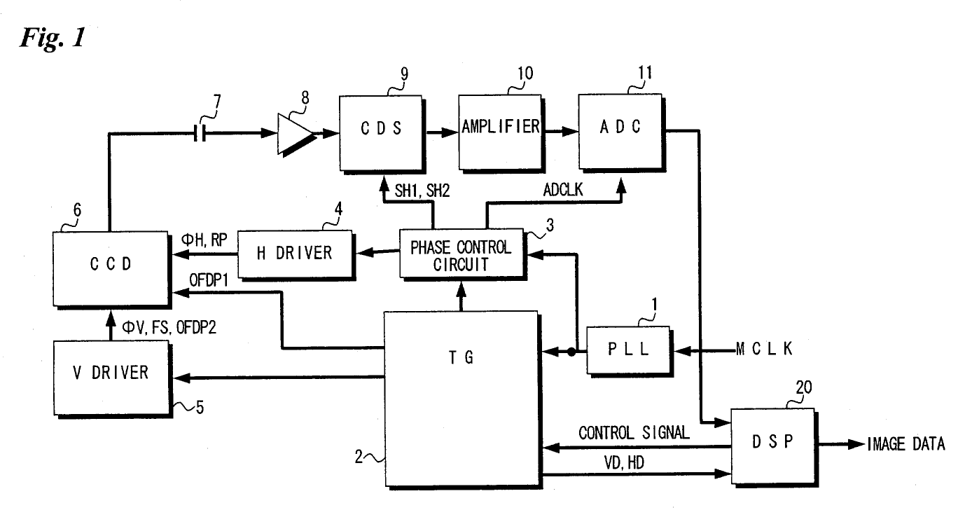

FIG. 1 is a block diagram illustrating part of the electrical structure of a digital still camera according to the present invention.

Master clock pulses MCLK are generated by an oscillator circuit (not shown) and the pulses are input to a PLL (Phase-Locked Loop) circuit 1. The latter provides master clock pulses MCLK of an established phase. The master clock pulses MCLK from the PLL circuit 1 are input to a timing generator 2 and a phase control circuit 3. The timing generator 2 generates various pulses, etc.

The various pulses generated by the timing generator 2 are input to the phase control circuit 3. The phase control circuit 3 outputs a first sampling pulse SH1 and a second sampling pulse SH2 for sampling in a correlated double sampling circuit 9, an AD clock pulse ADCLK and a signal for pulses, etc., for horizontal transfer of signal charge in a CCD 6. The signals SH1, SH2 are applied to the correlated double sampling circuit 9, the AD clock pulse ADCLK is applied to an analog/digital converter 11, and signal for the pulses are applied to a H driver 4, respectively.

The CCD 6 is of the interline type and has vertical transfer lines for vertically transferring signal charge that has accumulated in photodiodes, and a horizontal transfer line for transferring signal charge in the horizontal direction.

The H driver 4 generates horizontal transfer pulses φH for transferring signal charge horizontally and applies the pulses to the CCD 6. The H driver 4 further generates a reset pulse RP, which is applied to the CCD 6. An overflow drain pulse OFDP1 for the horizontal transfer line is applied to the CCD 6 from the timing generator 2.

A V driver 5 generates vertical transfer pulses φV for transferring signal charge in the vertical direction, field shift pulses FS for shifting signal charge, which has accumulated in the photodiodes, to the vertical transfer lines, and an overflow drain pulse OFDP2 for the vertical transfer lines. These pulses are applied to the CCD 6.

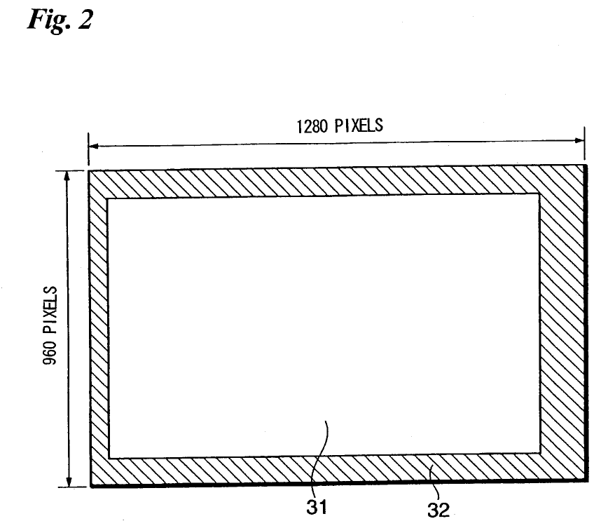

FIG. 2 illustrates the photoreceptor surface of the CCD 6.

The CCD 6 has 1280 pixels in the horizontal direction and 960 pixels in the vertical direction and includes an array of about 1,300,000 photodiodes (not shown).

The perimeter of the photoreceptor surface has an area 32. This area shall be referred to as an “ineffective pixel area” and is indicated by hatching. Signal charge that has accumulated in the photodiodes located in the ineffective pixel area 32 is not used in display of an image. The ineffective pixel area 32 is such that the side on the left of the photoreceptor surface has tens of pixels while the side on the right of the photoreceptor surface has about 100 pixels. An area (referred to as an “effective pixel area”) 31 is provided inside the ineffective pixel area 32. Signal charge that has accumulated in the photodiodes within the effective pixel area 31 is used in generating the image displayed on the display screen of the display unit. Accordingly, the image represented by the signal charge that has accumulated in photodiodes within the ineffective pixel area 32 does not appear on the display screen of the display unit.

With reference again to FIG. 1, signal charge that has been output from the CCD 6 is stored up in a capacitor 7 and converted to a video signal (referred to as a “CCD output signal”). The CCD output signal is input to the correlated double sampling circuit 9 via amplifier circuit 8.

Correlated double sampling is carried out by the correlated double sampling circuit 9 in accordance with the first sampling pulse SH1 and second sampling pulse SH2, as mentioned above. Correlated double sampling will be described in detail later.

The video signal output from the correlated double sampling circuit 9 is amplified by an amplifier circuit 10 and the output signal is input to an analog/digital converter 11. The latter converts the input video signal to digital image data. The digital image data resulting from the conversion is input to a digital signal processing circuit 20.

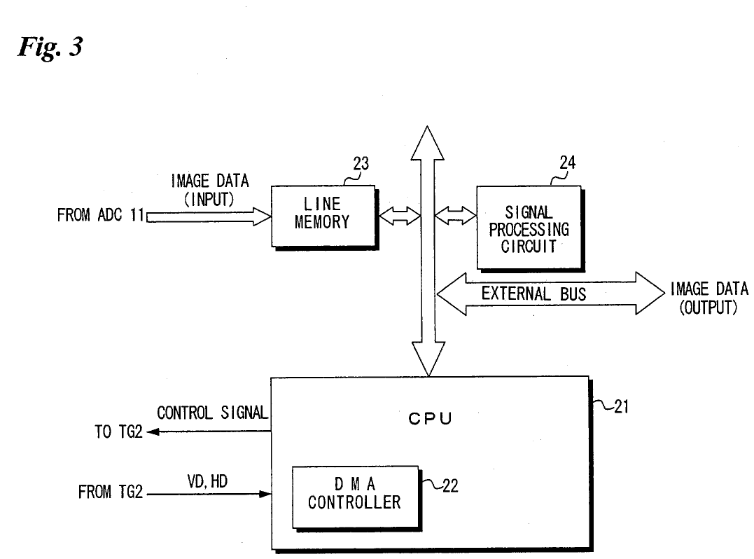

FIG. 3 is a block diagram illustrating the electrical structure of the digital signal processing circuit 20.

The digital signal processing circuit 20 includes a CPU 21 having a DMA controller 22. The CPU 21 outputs a control signal that is applied to the timing generator 2.

The video data output from the analog/digital converter 11 is applied to a line memory 23. The latter has a capacity for storing one horizontal scanning line of image data of the effective pixel area 31 of CCD 6. The one horizontal scanning line of image data that has been written to the line memory 23 is read out in accordance with transfer clock pulses of the DMA controller 22 and is input to a signal processing circuit 24. The latter executes predetermined signal processing such as a white balance adjustment. A vertical synchronizing signal VD and a horizontal synchronizing signal HD are applied to the signal processing circuit 24 from the timing generator 2. The signal processing circuit 24 adds these signals onto the image data. The image data output from the signal processing circuit 24 is delivered from the digital signal processing circuit 20 through an external bus.

Image data output from the digital signal processing circuit 20 is applied to the display unit, whereby the image of the subject obtained by imaging is displayed on the display screen. The image data is applied to and recorded on a memory card (not shown).

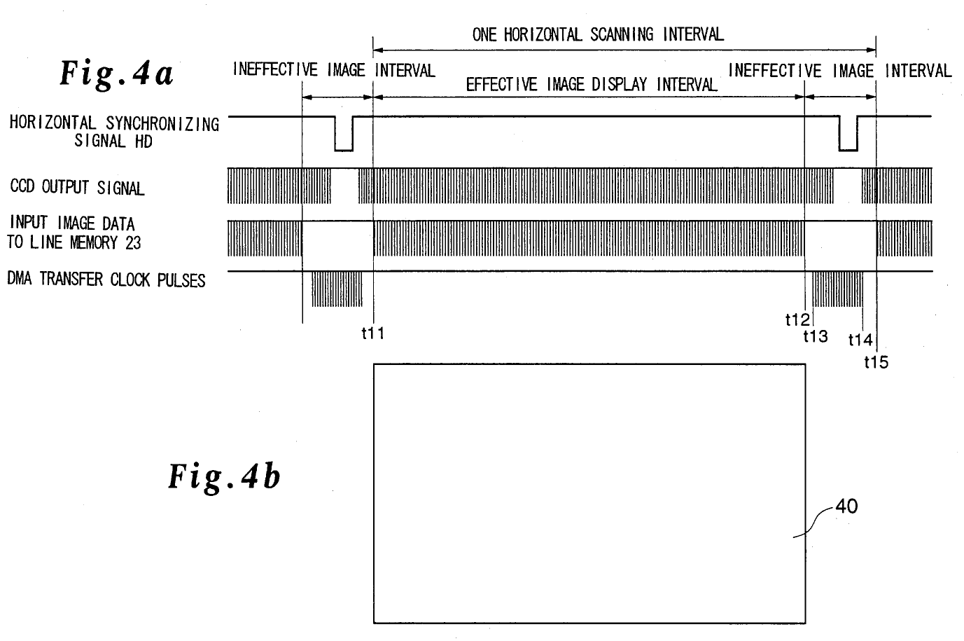

FIG. 4(A) is a time chart illustrating various signals associated with the digital still camera, and FIG. 4(B) illustrates the display screen of the display unit.

As mentioned above, a display screen 40 of the display unit corresponds to the effective pixel area 31 of the CCD 6, and image data obtained based upon signal charge that has accumulated in the photodiodes within the effective pixel area 31 is displayed on the display screen 40. An image represented by data obtained based upon signal charge that has accumulated in the photodiodes of the ineffective pixel area 32 of CCD 6 does not appear on the display screen 40.

In this embodiment, the interval in one horizontal scan over which signal charge that has accumulated in the effective pixel area 31 is read out (this is the interval in which the above-mentioned CCD output signal is obtained) shall be referred to as an “effective image display interval”, and the interval over which signal charge that has accumulated in the ineffective pixel area 32 is read out of the CCD 6 shall be referred to as an “ineffective image interval”.

Writing of one horizontal scanning line of image data (one horizontal scanning line of image data of the effective pixel area 31) to the line memory 23 is performed in the effective image display interval [e.g., time t11 to time t12 in FIG. 4(A)]. Read-out of one horizontal scanning line of image data from the line memory 23 is performed in accordance with DMA transfer clock pulses over a period (e.g., time t13 to time t14) in the ineffective image interval (e.g., time t12 to t15).

Processing from read-out of signal charge from the CCD 6 to writing of image data to the line memory 23 is executed in the effective image display interval, and read-out of image data from the line memory 23 is performed in the ineffective image interval. As a result, noise produced by read-out of image data from the line memory 23 can be prevented from being superimposed on the CCD output signal used in presenting a display on the display screen 40. Noise produced based upon read-out of image data from the line memory 23 will not be superimposed on the image displayed on the display screen 40.

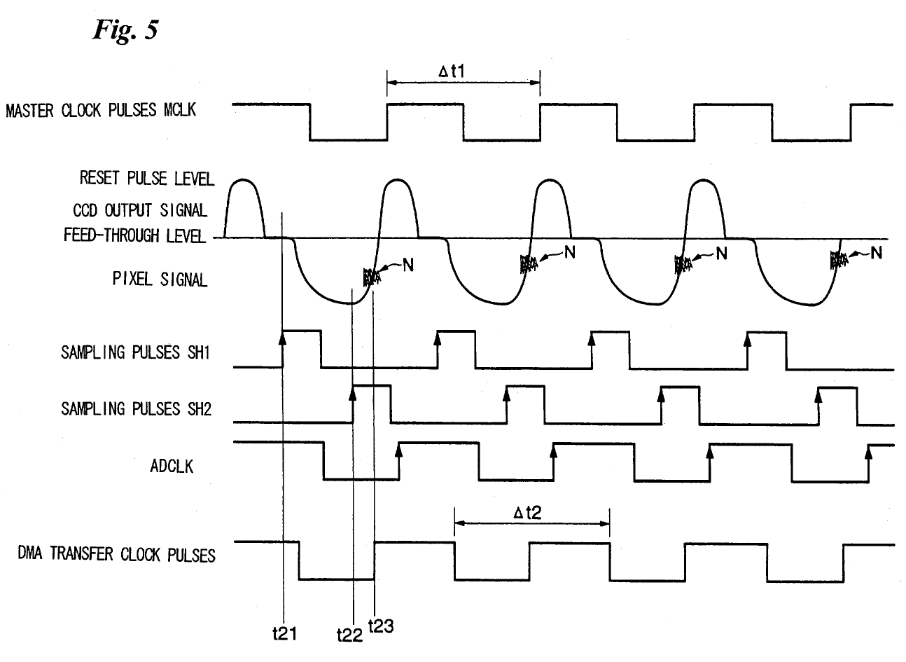

FIG. 5 is a time chart illustrating various signals, etc., associated with the digital still camera in accordance with another embodiment of the invention.

The above-mentioned master clock pulses MCLK have a period Δt1, and the DMA transfer clock pulses (read-out clock pulses) have a period Δt2. The periods Δt1, Δt2 are identical and the phase relationship between these two signals is fixed. One pixel's worth of the CCD output signal is obtained in correspondence with the period Δt1 of the master clock pulses MCLK.

The feed-through signal level of the CCD output signal is sampled (e.g., at time t21) in the correlated double sampling circuit 9 in accordance with a first sampling pulse SH1, and a pixel signal (i.e., a video signal, which corresponds to the amount of signal charge that has accumulated in the photodiodes of the CCD 6) is sampled (e.g., at time t22) in the correlated double sampling circuit 9 in accordance with a second sampling pulse SH2.

In this embodiment, the phase of the DMA transfer clock pulses is controlled in such a manner that the DMA transfer clock rises after the output of the second sampling pulse SH2. Owing to the rise (e.g., at time t23) of the DMA transfer clock pulse, noise N is generated and may be superimposed on the CCD output signal. But since the DMA transfer clock pulse rises after the output of the second sampling pulse SH2, sampling has already ended by the time the noise N is produced. Thus the effects of the noise N can be ignored. The image display on the display screen, therefore, is one from which noise has been eliminated.

As many apparently widely different embodiments of the present invention can be made without departing from the spirit and scope thereof, it is to be understood that the invention is not limited to the specific embodiments thereof except as defined in the appended claims.

What is claimed is:

1. An image sensing apparatus comprising:
a solid-state electronic image sensing device for sensing the image of a subject and outputting image data representing the image of the subject;
a line memory for storing one horizontal scanning line of image data obtained from an effective imaging area of said solid-state electronic image sensing device;
a control unit for controlling said line memory in such a manner that image data is output from said solid-state electronic image sensing device and, moreover, one horizontal scanning line of image data obtained from the effective imaging area is stored in an effective image display interval;
a read-out control unit for controlling said line memory in such a manner that one horizontal scanning line of image data is read out in an ineffective image interval; and
a display control unit for controlling a display unit so as to display one horizontal scanning line of an image represented by image data that has been read out of said line memory based upon control by said read-out control unit.

2. An image sensing apparatus comprising:
a solid-state electronic image sensing device for sensing the image of a subject and outputting a signal representing the image of the subject;
a sampling circuit for sampling, pixel by pixel, a video signal portion of the output signal from said solid-state electronic image sensing device;
an analog/digital converter circuit for converting the video signal portion, which has been sampled by said sampling circuit, to digital image data;
an image memory for storing digital image data obtained by the conversion by said analog/digital converter circuit and reading out the stored digital image data pixel by pixel in accordance with applied read-out clock pulses;
a read-out clock pulse control unit for controlling the read-out clock pulses in such a manner that they are applied to said image memory after sampling of the video signal portion in said sampling circuit; and
a display control unit for controlling a display unit so as to display an image represented by the image data output from said image memory.

3. A method of controlling an image sensing apparatus comprising the steps of:
sensing the image of a subject using a solid-state electronic image sensing device and obtaining image data representing the image of the subject;
obtaining image data from the solid-state electronic image sensing device and, moreover, writing one horizontal scanning line of image data obtained from an effective imaging area of the solid-state electronic image sensing device to a line memory in an effective image display interval;
reading one horizontal scanning line of image data out of the line memory in an ineffective image interval; and
controlling a display unit so as to display one horizontal scanning line of an image represented by image data that has been read out of the line memory.
